(19) United States
(12) Patent Application Publication
(10) Pub. No.: US 2002/0065568 A1
(43) Pub. Date: May 30, 2002

(54) Plug-in modules for digital signal processor functionalities

(76) Inventors: Robert Denton Silfvast, Belmont, CA (US); Philip J.E. Campbell, Palo Alto, CA (US); Scott Silfvast, Palo Alto, CA (US); Mark David Goodwin, Mountain View, CA (US); Andor Izsak, San Mateo, CA (US)

Correspondence Address: CENTRAL COAST PATENT AGENCY, PO BOX 187, AROMAS, CA, 95004, US

(21) Appl. No.: 09/727,909

(22) Filed: Nov. 30, 2000

(51) Int. Cl. G06F 17/00; G06F 15/16; G10L 11/00

(52) U.S. Cl. 700/94; 704/270; 704/278; 709/200; 381/61

(57) ABSTRACT

An electronic processing device for producing digitally processed audio-signal effects is provided. The electronic processing device comprises, an audio-signal input circuitry for receiving an audio input signal from a peripheral audio device, an audio-signal output circuitry for outputting the received audio-signal, the signal comprising a throughput signal after signal processing, a digital signal processor for applying audio-signal effects to the throughput audio-signal, one or more memory slots for receiving one or more modular memory components and an input control mechanism for controlling parameters of the throughput audio-signal. The one or more modular memory components are used as storage for externally sourced audio-signal effects such that when the one or more memory components are plugged into the electronic processing device, the processing device may utilize the effects applications stored on the one or more memory components in the processing of the throughput audio-signal. In preferred embodiments, the audio-effects applications are sourced on and retrieved from a data-packet-network through network-connection capability. In some embodiments, the electronic device is capable of independent network access and download of the effects applications and in other cases, a network host computer is used and the electronic device synchronizes to obtain new applications. Downloading the effects applications to the modular memory components for insertion into the device is also taught.

### FIELD OF THE INVENTION

The present invention is in the field of digital signal processing and pertains more particularly to improved methods and apparatus for user-performed signal customization.

### BACKGROUND OF THE INVENTION

At the time of the present invention digital signal processing is known to be among the fastest-growing segments of the semiconductor market, having processors used in a much broader range of diverse end-use markets than that of microprocessors. Digital signal processing is accomplished by means of a digital signal processor (DSP) chip, a special-purpose device built into a computer, audio workstation or other electronic device to perform array-processing operations. Many digital signal processors using current technology perform operations many times faster than general-purpose microprocessors produced using previous technology. Data processing speed is at the heart of the value that digital signal processors bring to the electronics market.

One use of signal processing technology in the music industry is in stomp boxes. A stomp box is a small electronic device frequently used by guitarists, keyboardists, singers, and other musicians and is usually placed on the floor connected by plugs and wires between the output of a guitar for example, and the input of an amplification or recording system. Signals are processed in a stomp box usually by manually actuating a foot switch, pedal, control knob or some other similar manual input mechanism. The signal processing algorithms performed by stomp boxes are commonly referred to as “effects.” Though originally containing dedicated analog circuitry, today quite often a DSP is used to create specific effects in those stomp boxes.

The appeal of stomp boxes is maintained by their simplicity, small size, affordability and a wide choice of effects algorithms, colors, shades, and styles available to the end-user. A typical stomp box however has only one or possibly a very few particular sounds or effects with a usually somewhat limited range of capabilities. A number of stomp boxes must be interconnected in a series in order for a user to expand the signal processing capabilities at hand. Such a configuration involves the use of many small conductive cords, or patch cords as they are commonly called, often the use of many batteries which must be frequently changed, and creates many inconveniences due to tangling of cords, amount of floor space required, and so on.

Over the past five years or so, the concept of plugins has become well established in the software industry. This concept involves a separation between large application programs and smaller “tool programs” called plugins. When attached to an application program, a plugin augments the functionality of that application program.

The plugin paradigm owes its success to the fact that “third party programmers” are free to develop the plugins themselves (using a software development kit defined by the plugin architecture). These programmers have been able to focus on implementing specific tools without having to worry about producing a complete application product. This has given rise to a new community of software developers who can generate very useful and innovative tool products (plugins) with very low business and development overhead. Plugins are used widely in many applications, but seem to be most predominant in web browsers and multimedia authoring or playback applications.

In recent years, plugins are finding great success as signal processing tools for digital audio workstations (DAWs). The audio signal processing industry is driven by creative technical people with a passion for audio and customers who are always looking for new and unique ways to process or manage sound. By opening up their signal path to third party developers, DAW companies have allowed their customers to tap into a large and growing list of interesting plugin tools, while allowing third party developers to reach an expanding market of customers. Over the past five years or so, dozens of plugin developers have created hundreds of plugin tools that can be used in DAW software applications. And the rate of development in this area is clearly increasing. When users apply these plugins in their DAW applications, they are able to enhance the quality or character of the sound or music they are producing.

The most widely used plugin architecture is Microsoft's DirectX. Other notable Plugin architectures for DAWs include Steinberg's VST (Virtual Studio Technology), Cakewalk's AudioX, and Digidesign's TDM. The general concept of plugins is not confined to the software industry; it applies to any product or technology that uses interchangeable tools or functions. While the DAW market has adopted the plugin paradigm with great success, the “audio appliance” market has not taken advantage of this paradigm. Audio appliances are dedicated hardware devices that perform specific tasks with audio. Examples range from hi-fi components to audio effects processors to karaoke machines to musical instruments to signal format converters. It is easily arguable that the majority of people who deal with audio on a hobby or semi-professional basis use appliances more than digital audio workstations (you don't see many computers in the average home stereo system, garage band studio, or music nightclub). There are tremendous numbers of audio appliances in use, and the market for audio appliances is very large (we have yet to assess its size with specific research). Furthermore, many users of audio appliances are interested in enhancing the sound quality of their audio. Finally, it is clear that more and more audio appliances are being designed with digital—rather than analog—signal paths.

While many audio appliances offer built-in signal processing capability, virtually none have been “opened up” to third party programming. Users of today's audio appliances are restricted to the signal processing capabilities that were programmed into the appliance by the manufacturer. This is rather limiting for either of two reasons: First, the signal processing is often not a top priority in the manufacturer's overall product development plan (particularly for consumer appliances) and has inferior quality. Second, the signal processing has a fixed number of algorithms or parameters, and thus has limited capability.

Since audio appliances are based on hardware, this plugin technology would need to be hardware-based. Of course, it must also be programmable so that it can run different plugin programs. This invention introduces a small and inexpensive—yet powerful—DSP module that provides a simple interface to the audio path inside the appliance, as well as a simple interface to a resource full of downloadable plugin programs. This resource would naturally be the Internet. Appliances would be built with a standard port that would accept this DSP module. Alternatively, the DSP module could be integrated inside the appliance for cost savings, but there would need to be a mechanism (e.g. memory cards) for loading new plugin programs into the DSP.

What is clearly needed is a system and method that enables users of various multi-effects signal processing systems and smaller single-effect floor processors to easily modify, update, and customize effects and settings, thereby greatly expanding the user's signal processing capabilities while using a minimum of hardware and software applications. Such a method and apparatus is described in enabling detail below.

Another important goal is to tap into the growing community of third-party DSP plugin developers. It is a goal of the invention to create a standard platform for enabling DSP plugins in audio appliances such as stomp boxes (in contrast to plugins for software-based applications such as DAWs) that can run DSP programs developed by many different people.

### SUMMARY OF THE INVENTION

In a preferred embodiment of the present invention, an electronic processing device for producing digitally processed audio-signal effects is provided. The electronic processing device comprises, an audio-signal input circuitry for receiving an audio input signal from a peripheral audio device, an audio-signal output circuitry for outputting a modified audio-signal, the modified signal comprising a throughput signal after signal processing, a digital signal processor for applying audio-signal effects to the throughput audio signal, and an input control mechanism for controlling parameters of the throughput audio signal. The one or more modular memory components are used, in a preferred aspect, as storage for externally sourced audio-signal effects applications such that when the one or more memory components are plugged into the electronic processing device, the processing device may utilize the effects applications stored on the one or more memory components in the processing of the throughput audio-signal.

In some applications, the external source for audio-signal effects is hosted on a data-packet-network, which is, in some instances, the Internet network. In one aspect, the peripheral audio device is a musical instrument. In this aspect, the one or more modular memory components may also include digital signal processing circuitry. The one or more modular memory components are, in some applications, programmable memory cards. In one aspect, the memory card is a flash memory card. In another application, the effects applications are software plug-ins configured for use on the electronic processing device.

In one aspect of the present invention, the electronic processing device further comprises, a processor for storing network-connection and navigation software, an input-controlled communication and display circuitry for enabling data-communication between the electronic processing device and a data source connected to the network and display of results of the communication and a cache memory for storing data downloaded from the network to electronic processing device. In this embodiment, a user operating the device may initiate connection to the network and may access the data source for the purpose of downloading audio-effect applications in the form of plug-ins to the cache memory on the electronic device whereupon the plug-ins may then be utilized by the device to enhance the throughput audio signal.

In certain aspects, the data communication network used to download applications to the device is the Internet network. In one aspect, the communication circuitry includes a wireless modem circuitry. In another aspect, the display circuitry enables a liquid crystal display screen or other display device installed on the device. In still another aspect, the display circuitry enables a light emitting display or indicator installed on the device. In yet another aspect, the communication circuitry includes a dial-up modem circuitry.

In another aspect of the present invention, hardware-software system for requesting and receiving audio-effects applications sourced on a data-packet-network for use on a requesting electronic processing device for producing digitally processed audio-signal effects is provided. The system comprises, a data-storage repository connected to the network, the repository for storing the audio-effects applications, a data server connected to network and having access to the data repository, the server for serving the audio-effects applications, and a network-capable processor connected to electronic processing device for enabling network-connection for the purpose of requesting and receiving the audio-effects applications. In a preferred use of the system, a user operating the electronic processing device may initiate network connection by virtue of the network-capable processor and download the audio-effects applications stored in the data-storage repository, the applications accessed and served thereto over the network by the data server.

In an alternative embodiment, the system is implemented on the Internet network. In one aspect, the network-capable processor is an internal processor running on the electronic processing device and the network connection is achieved through wireless Internet-access technology. In another aspect, the network connection is achieved through wired Internet-access technology.

In still another aspect of the present invention, a hardware-software system for requesting and receiving audio-effects applications sourced on a data-packet-network for use in an electronic processing device for producing digitally processed audio-signal effects is provided. The system comprises, a data-storage repository connected to the network, the repository for storing the audio-effects applications, a data server connected to the network and having access to the data repository, the data server for serving the audio-effects applications and an Internet-host computer connected to the network and having connection to the electronic processing device, the computer hosting network-connectivity on behalf of the electronic processing device. In preferred use of the system, a user operating the electronic processing device may connect to the host computer and retrieve audio-effects applications stored thereon, the audio-effects applications having been downloaded from the data-storage repository by virtue of network connection between the host computer and the data server. In some cases, access rights may be verified before access is granted, using such things as biometrics, smart cards, identification (ID) and password (PW), and so forth.

In a preferred embodiment, the hardware-software system is implemented on the Internet network. In one aspect, the Internet-host computer is a personal computer and the electronic processing device connects thereto by virtue of a serial connection. In one aspect, the serial connection is wireless. In another aspect, the serial connection is cabled.

In another aspect, the hardware-software system described above further comprises, a memory dock connected to the host computer, the memory dock for receiving a memory card, and a memory slot provided in the electronic processing device, the memory slot for receiving the memory card, such that the user docking the memory card into the memory dock connected to the host computer may download the audio-effects applications to the card, and by removing the memory card from the memory dock and inserting the card into the memory slot provided in the electronic processing device, may upload the audio-effects applications to be utilized by the processing device.

In one aspect, the memory dock is built into the host computer and has a memory address. In another aspect, the memory dock is cabled to the host computer as a peripheral device. In some aspects, the memory card is a flash-memory card. In a preferred application, the audio-effects applications are software plug-ins utilized on the electronic processing device. In some instances, the plug-ins are downloadable from memory drives built-in to the host computer. In these aspects, the memory drives are one of a hard disk drive, floppy drive, a zip drive, or a CD-ROM or any other non-volatile memory or storage.

In still another aspect of the present invention, a method for acquiring external audio-effects applications hosted on a data-packet-network for use in an electronic processing device, the device for producing digitally processed audio-effects signals is provided. The method comprises the steps of, (a) initiating network connection to the network hosting the audio-effects applications, (b) navigating to the network source responsible for serving the audio-effects applications, (c) requesting download of specific ones of the audio-effects applications available at the network source, (d) downloading the specified ones of the audio-effects applications to a memory storage and (e) utilizing specified ones of the audio-effects applications on the electronic processing device.

In a preferred embodiment, the method is practiced on the Internet network. In one aspect of the method in step (a), the network connection is initiated by a host computer. In another aspect of the method in step (a), the network connection is initiated by the electronic processing device. In the first described aspect, in step (b), the network source is a data server and navigation is performed by virtue of a browser application.

In one application of the method in step (d), the memory storage is a modular memory card. In this aspect, the memory card is docked as a peripheral device to the host computer, the computer downloading the audio-effects applications thereto. In this particular aspect of the method in step (e), the downloaded audio-effects applications are utilized by removing the memory card docked at the host computer after download, and inserting it into a memory slot provided in the electronic processing device. In one aspect of the method, steps (a)-(e) are practiced from the electronic processing device.

Now, for the first time, a system and method that enables users of various multi-effects signal processing systems and smaller single-effect floor processors to easily modify, update, and customize effects and settings, thereby greatly expanding the user's signal processing capabilities while using a minimum of hardware and software applications.

### BRIEF DESCRIPTION OF THE DRAWING FIGURES

FIG. 1 is a simplified block diagram of a typical single-function effects processor according to prior art.

FIG. 2a is a simplified block diagram of a plug-in digital effects processing system according to embodiment of the present invention.

FIG. 2b is a simplified flow diagram of a plug-in downloading system for digital effects processing according to an embodiment of the present invention.

FIG. 3a is a simplified block diagram of a series of connected single-function effects processors according to prior art.

FIG. 3b is a simplified block diagram of a typical multi-function effects processor according to prior art.

FIG. 4 is a simplified block diagram of a plug-in multi-function effects processing system according to embodiment of the present invention.

FIG. 5 is a simplified flow diagram software of a plug-in storage system according to another embodiment of the present invention.

FIG. 6 is a simplified block diagram of a utility for securing software according to an embodiment of the present invention.

### DESCRIPTION OF THE PREFERRED EMBODIMENTS

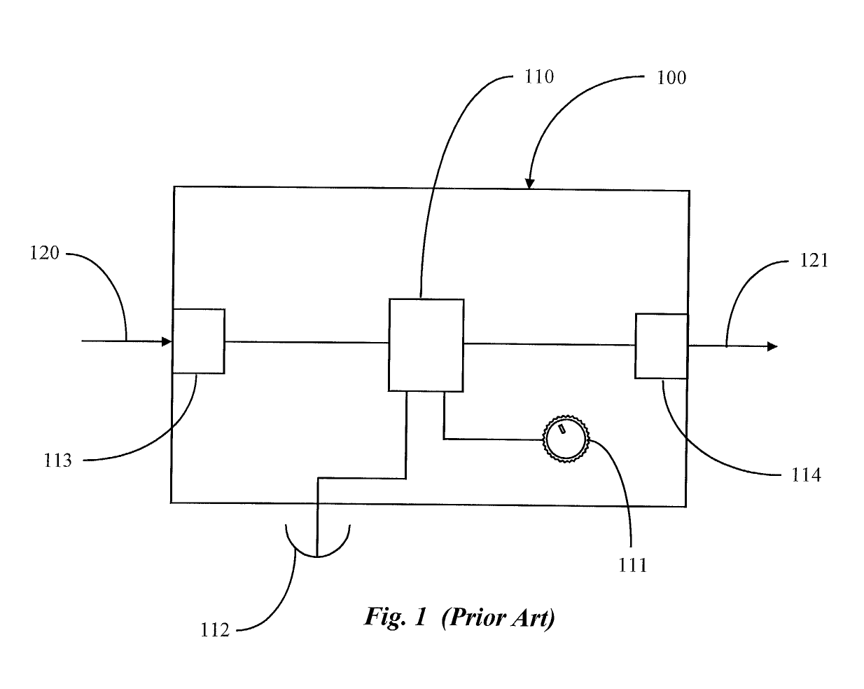

FIG. 1, labeled as prior art, is a simplified block diagram of a typical single-function effects processor 100, commonly used in conventional art by musicians such as guitarists and singers to change the audio effect of the amplified output signal by manipulating the input signals. Stomp box 100 has an input 120, typically a standard ¼ inch female plug standard in the industry. In a typical configuration the ¼ inch male end (connector) of a common conductive cord, not shown here, is inserted into input 120, the male end on the opposite end of the conductive cord being plugged into the signal source such as the output jack of a guitar or a singer's microphone. Input 120 is connected to a small circuit board for input signal pre-processing, shown here as input board 113. Stomp box 100 also has conventional main circuitry 110 shown in this view connected to input board 113. Main circuitry 110 has an array of electronic devices for signal processing, more modern circuitry sometimes using dedicated digital signal processing (DSP) as described in the background section. A signal provided by the source plugged into input 120 and subsequently pre-processed by input board 113 is then manipulated by the hardware and pre-programmed software of main circuitry 110.

Parameters and settings of the signal can be changed by the user using a common method such as control knob 111 as shown here. In this view control knob 111 can be assumed to be attached to a signal-manipulating device, either analog or digital in nature, which changes the sound character of the signal within main circuitry 110. A foot pedal, depicted in this simplified view as foot pedal 112, is often used with a control knob in a conventional stomp box such as the box 100, for the purpose of changing various parameters of the signal such as signal strength for volume control, or other changes affecting different frequencies of the audible sound produced by the connected amplification system, for example. In other examples a foot pedal such as described can be a stomp button used for actuating the circuitry, or could have some other purpose.

Stomp box 100 has an output board 114 connected to main circuitry 110 for the purpose of post-processing the signal prior to output through output 121. Output 121, connected to output board 114, is also typically a standard ¼ inch female plug similar to input 120. In a typical configuration the male end of a standard conductive cord, similar to that described for input 120, is inserted into output 121 providing a connection through which the processed output signal passes to the input plug of the amplification or recording system being used.

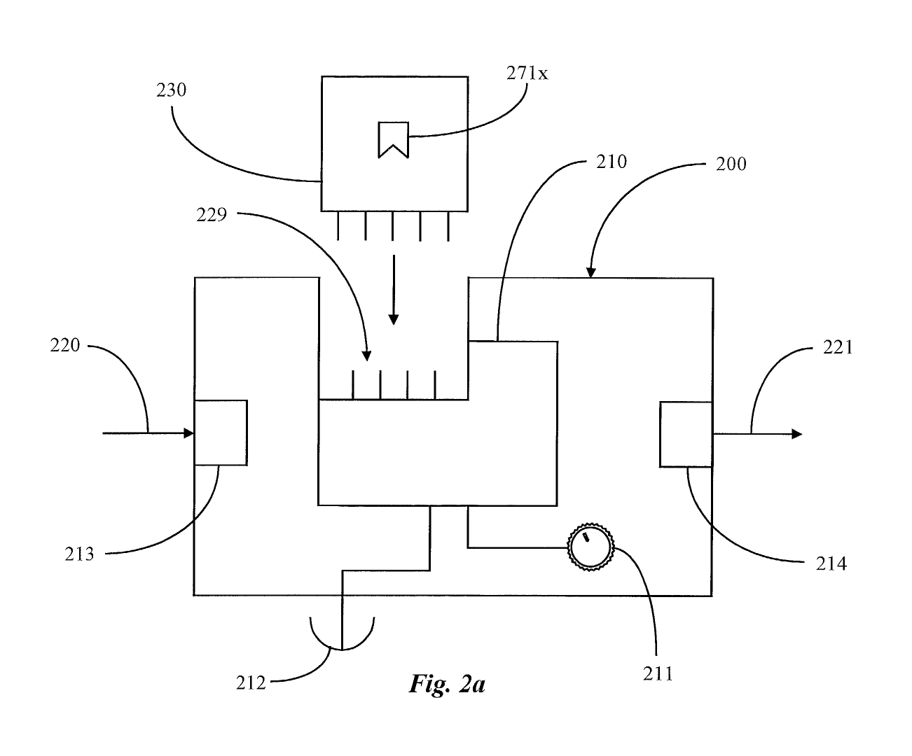

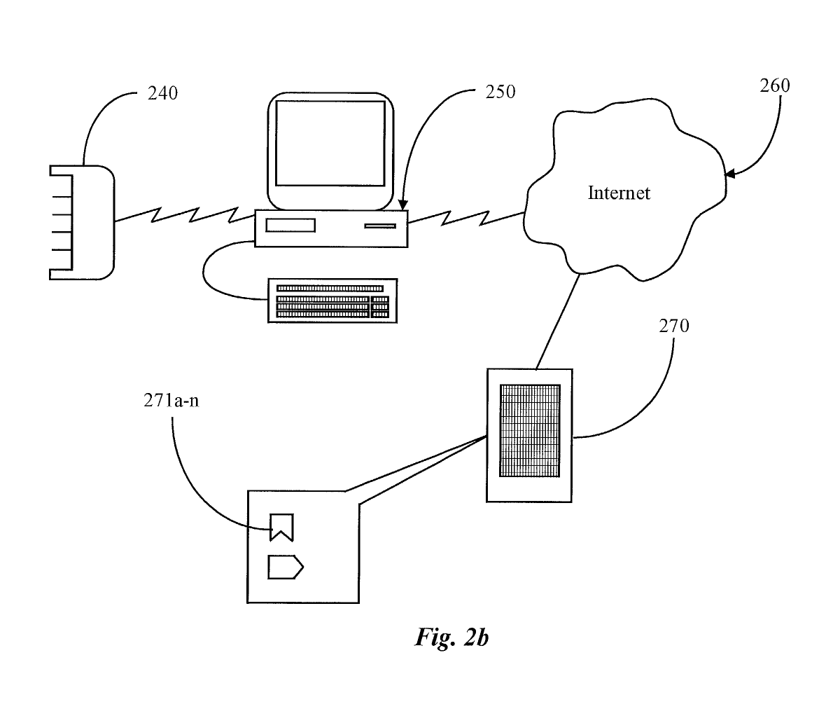

FIG. 2a is a simplified block diagram of a plug-in digital effects processing system according to embodiment of the present invention. Stomp box 200 is provided in this embodiment utilizing new and novel improvements that greatly enhance the digital signal processing capabilities of the single unit. Stomp box 200 has clear similarities to stomp box 100 of FIG. 1, such as overall size and shape, and shares many of the elements as well. Input 220 and input board 213 are provided in this embodiment and can be assumed to represent standard connection elements as is used for stomp box 100 of FIG. 1a. The same is true for output 221, output board 214, control knob 211 and foot pedal 212. As is also true for stomp box 100 of FIG. 1a, the use of control mechanisms such as control knob 211 or foot pedal 212 can vary, and one may exist without the other in alternative embodiments of the present invention without departing from the overall scope and spirit of new and novel improvements that will be described herein.

Stomp box 200 according to a preferred embodiment has a main circuitry 210 utilizing DSP technology with programming designed to perform a predetermined array of operations. Port 229 is provided in this embodiment as a plug-in connector socket into which a module 230, as shown here, can be inserted in the direction indicated and seated within stomp box 200. Module 230 may contain one or several software plug-ins, represented in this view as software module 271x. Module 230 in different embodiments can be a flash memory unit similar to those standard in the industry, or may be either a non-volatile and/or expandable memory module. In other alternative embodiments module 230 may also incorporate DSP technology within its circuitry, which would allow a user to perform real-time upgrades or customizations to the stomp box's DSP capabilities as desired. Once a programmed module 230 is plugged into port 229, stomp box 200 performs one or several specific functions, musical effects for example, according to the software programming of module 230.

FIG. 2b is a simplified flow diagram of a plug-in downloading system for digital effects processing according to an embodiment of the present invention. Personal computer 250 is shown connected to Internet 260 from which a variety of software plug-ins, represented here as 271a-n as supplied by Internet server 270, can be downloaded utilizing downloading methods generally known in the art. Adapter 240 is provided in this embodiment, designed as a connection socket to accommodate plug-in module 230, and is connected to a personal computer 250 utilizing various means common in the industry, such as a USB connection for example. By connecting module 230 to personal computer 250 in this manner software programming of module 230 can be performed by downloading various effects and settings directly from personal computer 250 into module 230. In some cases, a multitude of Internet server sites may exist, each having a variety of customized software plug-ins available for download, thereby greatly increasing the variety of software available to the end-user. The thing that will “greatly increase the variety of software available” will not be the number of Internet download sites, but rather the number of third party developers that adopt the platform and write plugins for it. New and constantly updated software plug-ins can be created and made available to the general public through the Internet for downloading. In addition to acquiring software plug-ins for module 230 by downloading from the Internet into a personal computer such as described, a user may choose to maintain a particular customized set of software files within the personal computer so as not to be required to make frequent Internet connections for downloading. In addition to downloading from the Internet, software plug-ins in other cases may be acquired by the user in other media forms such as compact disc, for example, and installed into the storage of the personal computer. In some cases, access rights may be verified before access is granted, using such things as biometrics, smart cards, identification (ID) and password (PW) etc. In yet other cases, the user can upload his configuration to a server on the Internet, as discussed below.

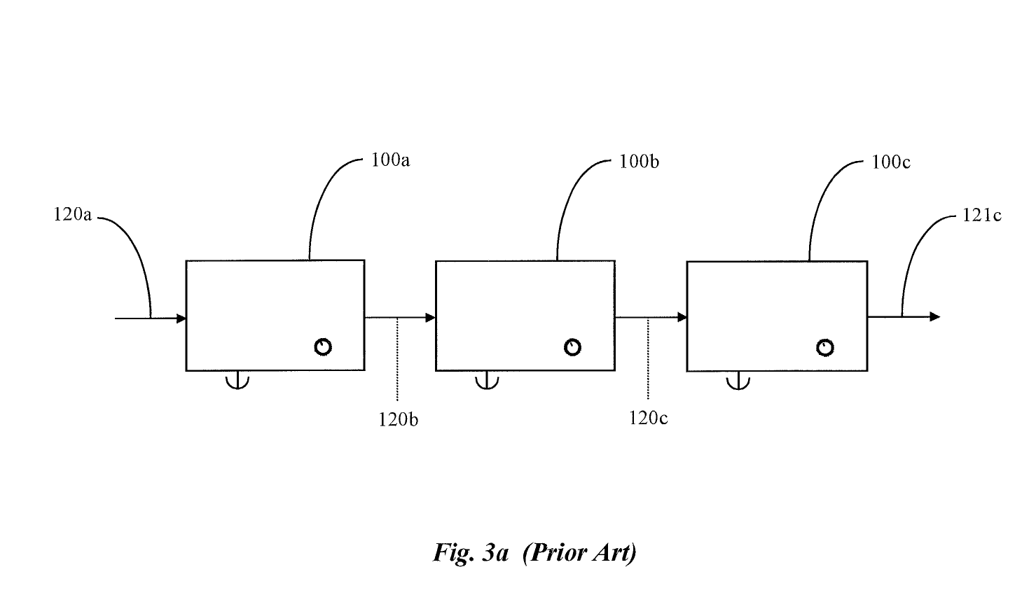

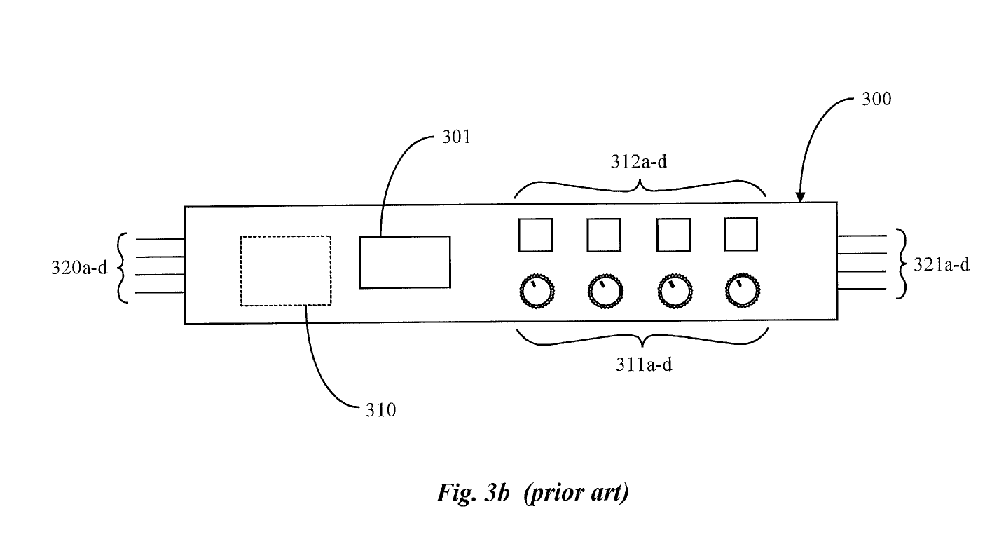

FIG. 3a, labeled as prior art, is a simplified block diagram of a series of connected single-function effects processors. It is common in the industry for a musician playing guitar for example, to interconnect a plurality of individual single-effect stomp boxes in order to achieve the desired character of sound and combination of sound effects. Stomp boxes 100a, 100b, and 100c are of conventional design and similar to stomp box 100 of FIG. 1a. Input 120a is analogous to input 120a FIG. 1a. The output of stomp box 100a is connected to the input of stomp box 100b by using an output/input connection represented in this view as 120b, and is a common connection cord standard in the industry. Stomp box 100b is subsequently connected to stomp box 100c in similar fashion using connection 120c, which is identical to connection 120b. The processed signal produced by the sequenced single-function effects processors is sent through output 121c for recording or amplification. It is quite possible also, and often used although not explicitly shown in FIG. 3a, for stomp boxes to be connected in parallel with a common output junction so a user may select among several effects to be rendered as options rather than in tandem.

FIG. 3b, also labeled prior art, is a simplified block diagram of a typical multi-function effects processor. Effects processor 300 is a typical rack-mounted unit commonly used in recording studios or in performances, and combines the signal processing capabilities of multiple single-function effects processors, either in parallel or series or a mixture of both. Signals for processing enter the unit through inputs 320a-d, and once processed, exit the unit through outputs 321a-d. Inputs 320a-d and outputs 321a-d, in various cases, may be either internally connected with no external access, or may be externally accessible mechanisms known in the industry. The internal circuitry of effects processor 300 is symbolically represented in this view as element 310. A simple LCD display 301 for displaying current functions and settings is also shown, as are the multitude of control elements represented as control elements 311a-d and 312a-d.

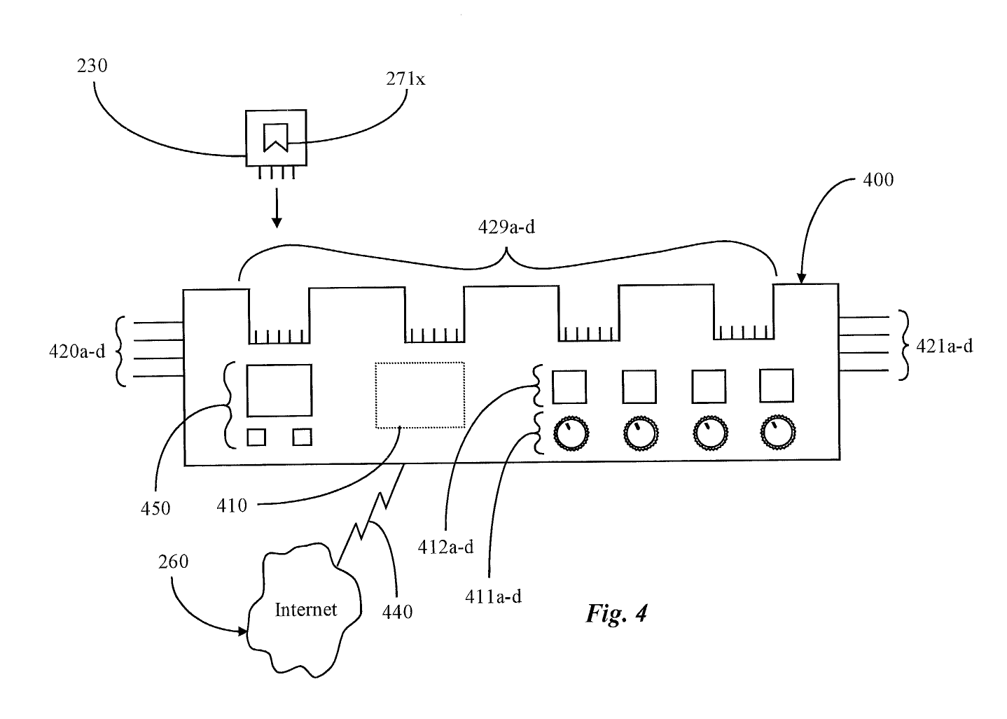

FIG. 4 is a simplified block diagram of a plug-in multi-function effects processing system according to embodiment of the present invention. Multi-function effects processor 400 is provided in this embodiment has some similarities to effects processor 300 of FIG. 3b, but processor 400 is utilizing new and novel improvements that greatly enhance a user's digital signal-processing capabilities. Multi-function effects processor 400 has several similarities to effects processor 300 of FIG. 3b. Module ports 429a-d are provided in this embodiment, each similar in function and appearance to module port 229 of stomp box 200 of FIG. 2a, designed for the insertion of software plug-in module 230. Various alternative embodiments may contain a single module port 429 or may have a plurality of module ports varying in number and placement. Module 230 has a software plug-in represented as 271x and as previously described, may in some cases contain additional digital signal processors and may have more than one effect programmed therein.

Internet connection 440 is provided in this embodiment enabling a user to download software plug-ins from the Internet, represented in this diagram as Internet 260. A user interface is provided in this embodiment by an LCD display 450 and associated input buttons, providing the user input capabilities when downloading software, or may also be used to configure correlation between effects and control buttons. Other displays or output methods and input methods may be used, including but not limited to, for example voice activation etc. In alternative embodiments some user interface functions may be performed remotely by the user using a box with buttons or switches, or in some cases a GUI running on a personal computer, connected by either a wire or wireless connection. Inputs 420a-d are provided in this embodiment and represent standard connection elements as are used for effects processor 300 of FIG. 3b. The same is true for outputs 421a-d, and control elements 411a-d and 412a-d.

Effects processor 400 according to a preferred embodiment has a main circuitry 410 that may in various embodiments contain one or a plurality of digital signal processors. Control elements 411a-d and 412a-d are also shown in this view as similar to those of conventional effects processor 300. As is also true for effects processor 300 of FIG. 3b, the function, placement and number of common elements can vary in alternative embodiments of the present invention without departing from the overall scope and spirit of new and novel improvements described herein.

The embodiment of FIG. 4 has a direct Internet connection; therefore, in some cases, it is not essential to provide memory cards as the means for loading different plugins into the unit (although the memory cards might still be useful for non-volatile storage of plugins or for transferring plugins to other audio appliances). One might envision a rack-mount effects unit that simply has access to all plugins at the host Internet site at all times (kind of like a digital cable TV box: it keeps track of what you download and relays that info to the subscription provider so they can bill your account).

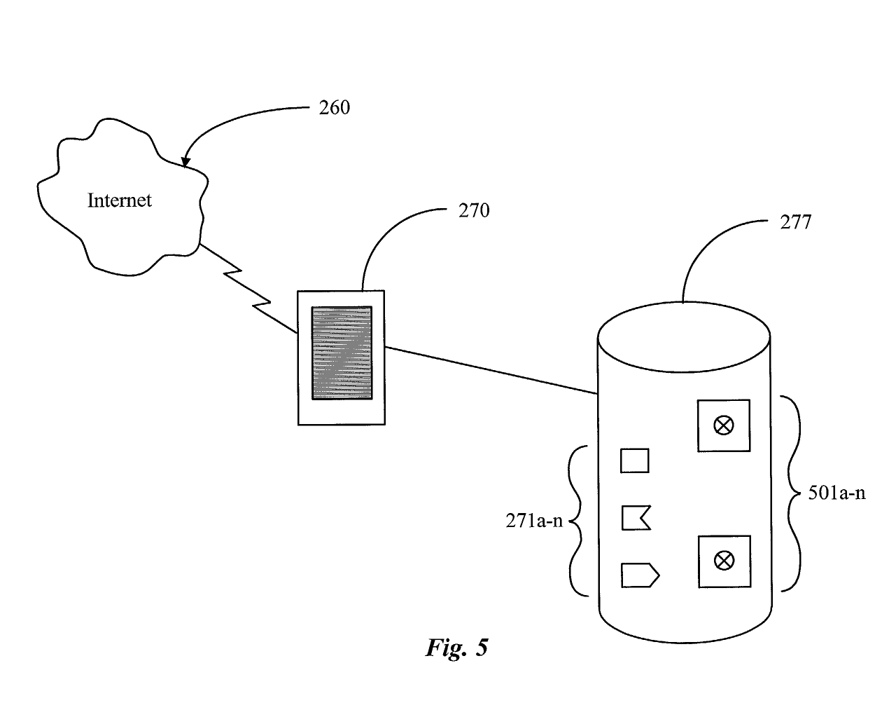

FIG. 5 is a simplified overview diagram of a software plug-in storage system according to another embodiment of the present invention. The typical architecture of a server such as server 270 shown here, having a hard disk or other mass storage 277 storing software plug-ins 271a-n. Software protection and security may be maintained within the storage of server 270 by utilizing software utilities commonly referred to as lock boxes, allowing programmers to prevent the download or manipulation of certain software programs, such as private plug-in, authorization keys, and configuration information for example. Such lock boxes are represented in this view as lock boxes 501a-n.

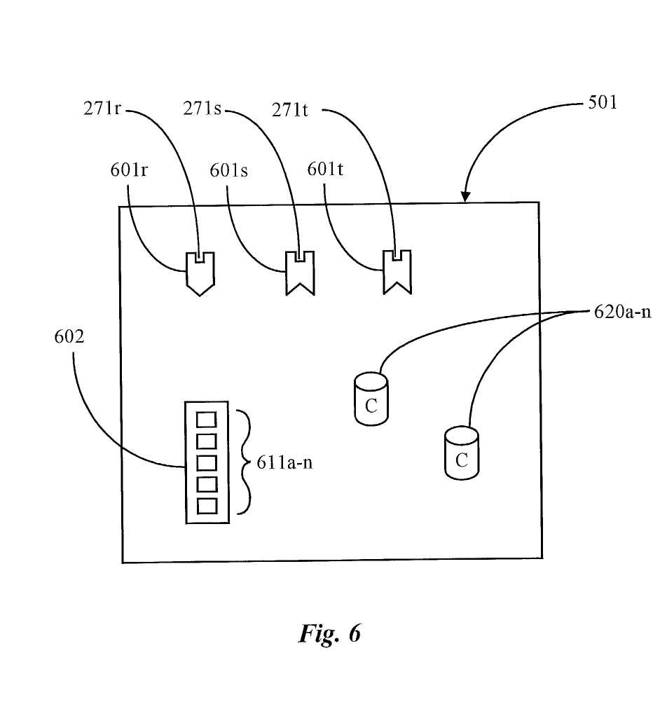

FIG. 6 is a simplified block diagram of a utility for securing software according to an embodiment of the present invention. In this view a software lock box 501 of storage 277 of FIG. 5 is shown in greater detail. Lock box 501 contains software plug-in 271r and 271s represented in this view as high-end plug-ins requiring an authorization key input into key locations 601r and 601s before the plug-ins can be used. A key box 602 within lock box 501 contains several software keys 611a-n allowing a user such as a sound engineer for example, by utilizing configuration storage parameters 620, to easily customize and store a specific configuration of settings at one studio and then download the configuration and settings to another platform at a different studio. In a preferred embodiment of the present invention software keys are separated from actual software plug-ins within the storage system so that multiple versions of plug-ins may be made available for different digital signal processors contained in a variety of hardware equipment. This allows the user to download the correct type of stored plug-in to match the requirements of differing digital signal processors installed in equipment used in different studios. For example, lock box 501 shows a software plug-in 271s designed for a particular digital signal processor to be used with key location 601s, and a second plug-in 271t designed for a different digital signal processor and used with key location 601t. When the desired configuration is downloaded, the system recognizes that a different plug-in is required, and accordingly downloads the correct plug-in, and searches accordingly for the correct key from key box 602. Software keys such as described can also be used to control the usage of software plug-ins. For example, software keys can be set up within a lock box to allow Internet download to the general public for a limited duration, or may allow modifications of plug-in parameters only up to a certain degree, or they may be set up to allow for only a one-time or limited number of usage sessions.

In an alternative embodiment of the invention the DSP chip is contained in the modular, removable card or cartridge. There are several advantages to such an implementation:

(1) Audio appliances can be designed more simply: The manufacturers need merely to include in their products a socket to accept this modular DSP card. Thus, a manufacturer does not need to have DSP expertise in order to add sophisticated DSP processing to their product.

(2) A given appliance can support future improvements in DSP technology and performance, as the modular DSP cards can be redesigned every year to include the latest technology. The base appliance should be able to support many future generations of DSP cards, as it only needs to provide audio I/O and a control interface to the DSP card.

(3) At any given time, there might be different types of DSP cards (using different DSP chipsets or varying levels of performance) that are all compatible with the same plugin socket. Users would feel that they have more choices, and plugin developers might find different cards suitable for different algorithms.

(4) There might be compatibility issues between various memory cards and DSP chipsets, especially as technology progresses. Furthermore, the interface from a DSP chip to external memory typically uses many pins. By integrating the memory and the DSP chipset on the same card, the interface socket needs only to provide pins for audio I/O and control signals (e.g. three serial ports).

(5) There are many examples of audio signal processing devices that utilize memory cards for expanding processing capabilities. Examples include the Korg M3R rackmount synth, the Yamaha DX7, and several effects processors on the market (e.g. TC Fireworx, Roland SRV-3030D). While some of these allow storage of parameters for algorithms, that reside in the main units, to the cards, the concept of a removable module that actually contains the complete algorithm, or allows to download it, and in some cases even processes the signal is clearly different from the parameter memory card solution seen in prior art.

It will be apparent to the skilled artisan that the examples presented as prior art and as embodiments of the present invention above are relatively simple, and in real cases there can be many more elements than those described herein. The simple diagrams, however, presented herein are sufficient to describe the system and practice of the present invention and for these reasons must be accorded the breadth of the claims, which follow:

What is claimed is:

1. An electronic processing device for producing digitally processed audio-signal effects comprising:
an audio-signal input circuitry for receiving an audio input signal from a peripheral audio device;
an audio-signal output circuitry for outputting the received audio-signal, the signal comprising a throughput signal after signal processing;
a digital signal processor for applying audio-signal effects to the throughput audio-signal;
one or more memory slots for receiving one or more modular memory components; and
an input control mechanism for controlling parameters of the throughput audio signal, characterized in that the one or more modular memory components are used as storage for externally sourced audio-signal effects applications such that when the one or more memory components are plugged into the electronic processing device, the processing device may utilize the effects applications stored on the one or more memory components in the processing of the throughput audio signal.

2. The device of claim 1, wherein the external source for audio-signal effects is hosted on a network to which the electronic processing device may interface.

3. The device of claim 2, wherein the network is the Internet network.

4. The device of claim 1, wherein the peripheral audio source device is a musical instrument.

5. The device of claim 1, wherein the one or more modular memory components include digital signal processing circuitry.

6. The device of claim 1, wherein the one or more modular memory components are programmable memory cards.

7. The device of claim 6, wherein the memory card is a flash memory card.

8. The device of claim 1, wherein the effects applications are software plug-ins configured for use on the appliance.

9. The device of claim 2, further comprising:
a processor for storing network-connection and navigation software;
an input-controlled communication and display circuitry for enabling data-communication between the electronic processing device and a data source connected to the network and display of results of the communication; and
a generic memory for storing data downloaded from the network to electronic processing device, wherein a user operating the device may initiate connection to the network and may access the data source for the purpose of downloading audio-effect applications in the form of plug-ins to the cache memory on the electronic device whereupon the plug-ins may be utilized by the device to enhance the throughput audio.

10. The device of claim 9, wherein the network is the Internet network.

11. The device of claim 9, wherein the communication circuitry includes a wireless modem circuitry.

12. The device of claim 9, wherein the display circuitry enables a liquid crystal display screen installed on the device.

13. The device of claim 9, wherein the display circuitry enables a light emitting display screen installed on the device.

14. The device of claim 9, wherein the communication circuitry includes a dial-up modem circuitry.

15. A hardware-software system for requesting and receiving audio-effects applications sourced on a data-packet-network for use on a requesting electronic processing device for producing digitally processed audio-signal effects comprising:
a data-storage repository connected to the network, the repository for storing the audio-effects applications;
a data server connected to network and having access to the data repository, the server for serving the audio-effects applications; and
a network-capable processor connected to electronic processing device for enabling network-connection for the purpose of requesting and receiving the audio-effects applications, wherein a user operating the electronic processing device may initiate network connection by virtue of the network-capable processor and download the audio-effects applications stored in the data-storage repository, the applications accessed and served thereto over the network by the data server.

16. The hardware-software system of claim 15, wherein the data-packet-network is the Internet network.

17. The hardware-software system of claim 15, wherein the network-capable processor is an internal processor running on the electronic processing device.

18. The hardware-software system of claim 16, wherein the network connection is achieved through wireless Internet-access technology.

19. The hardware-software system of claim 16, wherein the network connection is achieved through wired Internet-access technology.

20. A hardware-software system for requesting and receiving audio-effects applications sourced on a data-packet-network for use in an electronic processing device for producing digitally processed audio-signal effects comprising:
a data-storage repository connected to the network, the repository for storing the audio-effects applications;
a data server connected to the network and having access to the data repository, the data server for serving the audio-effects applications; and
an Internet-host computer connected to the network and having connection to the electronic processing device, the computer hosting network-connectivity on behalf of the electronic processing device; wherein a user operating the electronic processing device may connect to the host computer and retrieve audio-effects applications stored thereon, the audio-effects applications having been downloaded from the data-storage repository by virtue of network connection between the host computer and the data server.

21. The hardware-software system of claim 20, wherein the data-packet-network is the Internet network.

22. The hardware-software system of claim 20, wherein the Internet-host computer is a personal computer and the electronic processing device connects thereto by virtue of a serial connection.

23. The hardware-software system of claim 22, wherein a serial connection is wireless.

24. The hardware-software system of claim 22, wherein the serial connection is cabled.

25. The hardware-software system of claim 20, further comprising:
a memory dock connected to the host computer, the memory dock for receiving a memory card; and
a memory slot provided in the electronic processing device, the memory slot for receiving the memory card, such that the user docking the memory card into the memory dock connected to the host computer may download the audio-effects applications to the card, and by removing the memory card from the memory dock and inserting the card into the memory slot provided in the electronic processing device, may upload the audio-effects applications to be utilized by the processing device.

26. The hardware-software system of claim 25, wherein the memory dock is built into the host computer.

27. The hardware-software system of claim 25, wherein the memory dock is cabled to the host computer as a peripheral device.

28. The hardware-software system of claim 25, wherein the memory card is a flash-memory card.

29. The hardware-software system of claim 25, wherein the audio-effects applications are software plug-ins utilized on the electronic processing device.

30. The hardware-software system of claim 29, wherein the plug-ins are downloadable from memory drives built-in to the host computer.

31. The hardware-software system of claim 30, wherein the memory drives are one of a hard disk drive, a floppy drive, a zip drive, or a CD-ROM.

32. A method for acquiring external audio-effects applications hosted on a data-packet-network for use in an electronic processing device, the device for producing digitally processed audio-effects signals comprising the steps of:
(a) initiating network connection to the network hosting the audio-effects applications;
(b) navigating to the network source responsible for serving the audio-effects applications;
(c) requesting download of specific ones of the audio-effects applications available at the network source;
(d) downloading the specified ones of the audio-effects applications to a memory storage; and
(e) utilizing specified ones of the audio-effects applications on the electronic processing device.

33. The method of claim 32, wherein the data-packet-network is the Internet network.

34. The method of claim 32 wherein in step (a), the network connection is initiated by a host computer.

35. The method of claim 32 wherein in step (a), the network connection is initiated by the electronic processing device.

36. The method of claim 32 wherein in step (b), the network source is a data server and navigation is performed by virtue of a browser application.

37. The method of claim 32 wherein in step (d), the memory storage is a modular memory card.

38. The method of claim 37 wherein in step (d), the memory card is docked as a peripheral device to the host computer, the computer downloading the audio-effects applications.

39. The method of claim 38 wherein in step (e), the downloaded audio-effects applications are utilized by removing the memory card docked at the host computer after download, and inserting it into a memory slot provided in the electronic processing device.

40. The method of claim 32 wherein steps (a)-(e) are practiced from the electronic processing device.
